(19) United States
(12) Patent Application Publication
(10) Pub. No.: US 2007/0179875 A1
(43) Pub. Date: Aug. 2, 2007

(54) Method for wirelessy real-time transmission of financial stock graphs and device of the time

(76) Inventor: Hung-Che Chiu, Taipei (TW)

Correspondence Address: RABIN & Berdo, PC, 1101 14TH STREET, NW, SUITE 500, WASHINGTON, DC, 20005, US

(21) Appl. No.: 11/640,991

(22) Filed: Dec. 19, 2006

Related U.S. Application Data
(63) Continuation of application No. 09/688,986, filed on Oct. 17, 2000, now abandoned.

(51) Int. Cl. G06Q 40/00

(52) U.S. Cl. 705/35

(57) ABSTRACT

A method for wirelessly real-time transmission of financial stock graphs and device of the same are disclosed, in which, a hyper text transfer protocol transmission servo module (HTTP transmission servo module) is added to a conventional finical quotation terminal. The hyper text transfer protocol transmission servo module is connected to a mobile network through an Ethernet, or a serial communication interface and a modem. The HTTP transmission servo module is further connected to a far-end wireless application protocol gateway (WAP gateway) 6 of a wireless digital system, such as GSM or CDMA for acquiring the service of translating the real-time graph information. The present invention is accessed to a subscriber's device of a mobile phone or a personal digital assistant. The user can remotely control the real-time service of the finical quotation terminal through the operating interface of the wireless mark language (WML) transferred from the hyper text transfer protocol transmission servo module. The user can enter into the HTTP transmission servo module of the finical quotation terminal from a user's premise through a wide area network (Wan) and read the data in a database according to a specific commodity. Then the data is directly translated and compressed into a WBMP graphic file matching with the specification of wireless device bitmap coordinate established by the Wireless Application Protocol Forum. The transmission to the far-end user is performed through the HTTP transmission servo module. Since the graphic file is not optically scanned after printed through a printer, it is not performed in-time and has a lower resolution. In fact, the graphic file is from a real-time market data and then is converted into a digital graphic file and it is directly transferred through a digital protocol, therefore, it is provided in time and has a high resolution.

### FIELD OF THE INVENTION

The present invention relates to a method for wirelessly real-time transmission of financial stock graphs and device of the same, and especially to a method and device for upgrading a conventional finical quotation terminal (including stocks, exchanges, and futures). Thereby, a far-end user can acquire the real-time dynamic trend graphs, news and other finical information through a wireless transmission device supporting a WML format.

### BACKGROUND OF THE INVENTION

Although the conventional finical quotation terminal can be provided the real-time prices, graphs, institutional person buying and selling lists, buying and selling alarms, etc. during trading hours, as shown in FIG. 1.

However, these results are only displayed in the screen of the terminal, while a far-end user can not share the real-time inputting information.

For example, if a far-end user needs a real-time graph of a certain stock, there are several steps and conditions are necessary as described in the following:

In first way, as shown in FIG. 2, the condition required is a quotation terminal, an operator a printer, a scanner, a fax servo, a telephone, and a facsimile machine.

The required steps are
1. printing the graph through the printer by the operator;
2. scanning the graph through a scanner;
3. receiving/transmitting the fax data through the fax servo;
4. transmitting the specific graph through a public telephone service network by the operator; and
5. faxing to the terminal of the subscriber, therefore, the subscriber may acquire the graph by himself (or herself)

However, this process is not performed in time and twice distortions induce.

The second way is illustrated in FIG. 3, the condition required is a quotation terminal, an operator, a printer, a scanner, a network terminal, and a subscriber software of an e-mail.

The required steps are
1. printing the graph through the printer by the operator;
2. scanning the graph through a scanner;
3. receiving/transmitting the graph by e-mail through the network terminal;
4. transmitting the specific graph to the network terminal of the subscriber, therefore, the subscriber may acquire the graph by himself (or herself)

However, this process is not performed in time and twice distortions induce.

Therefore, it is appreciated that the conventional finical quotation terminal has the conventional function of real-time graph displaying, while it is only controlled locally instead of being controlled remotely.

Furthermore, the conventional finical quotation terminal only serves for a single person at a time. It can not be shared by many persons simultaneously.

### SUMMARY OF THE INVENTION

Accordingly, the primary object of the present invention is to provide method for wirelessly real-time transmission of financial stock graphs and device of the same, thereby, other than the conventional ways for using the system, the far-end users also share the resource so that the expensive finical quotation terminal is unnecessary. For example many users with wireless transmission devices may distribute in many places but still acquire the finical quotation information, graphs, news and others through those wireless-devices.

Another object of the present invention is to provide a method for wirelessly real-time transmission of financial stock graphs and device of the same. Not only the conventional function is used, but also the far-end users may share the resources simultaneously. Therefore, the general customers never need an expensive computer finical quotation terminal, but to share the real-time resource. For example, multiple users may distribute remotely in many places, however, they may acquire the finical quotations, analyzing graphs, and news from dedicated wireless devices.

In the present invention, a method for wirelessly real-time transmission of financial stock graphs and device of the same are provided. An Ethernet, or a serial communication interface and a modem are further added to be connected by an external wide area network or an Internet. Furthermore, a serve interface of the hyper text transfer protocol transmission servo module (HTTP 1.0/HTTP 1.1) established by the world wide web consortium (W3C) is added to an internal system of the finical quotation terminal as a standard of a far-end mobile network. Furthermore, the data processing way of the finical quotation graph and the output process is translated in time as a standard WBMP graphic file supported by mobile receiving devices (for example, mobile phones, or personal digital assistants) for being transferred to a far-end wireless network.

The various objects and advantages of the present invention will be more readily understood from the following detailed description when reading in conjunction with the appended drawing.

### BRIEF DESCRIPTION OF THE DRAWINGS

FIG. 1 shows the functions of a conventional finical quotation terminal.

FIG. 2 is a flow diagram for faxing a graph in a conventional finical quotation terminal.

FIG. 3 is a flow diagram showing the process of e-mailing a graphic file in a conventional finical quotation terminal.

FIG. 4 is a block diagram showing the generation of a graphic file in the finical quotation terminal of the present invention.

FIG. 5 is a flow diagram showing the system of a finical quotation terminal in the present invention.

FIG. 6 is a flow diagram showing the manufacturing of a real-time graphic generating module in the finical quotation terminal of the present invention.

FIG. 7 shows the wire connections of the finical quotation terminal according to the present invention with a system host of a data source.

FIG. 8 shows the function construction of the finical quotation terminal in the present invention.

FIG. 9 is a description about the use of the information of an individual stock according to the present invention.

FIG. 10 is a description about the use of the general stock market information of the present invention.

FIG. 11 is a description about the operation of the stock directory inquiry function of the present invention.

FIGS. 12A and 12B is a description about the operation of global finical information inquiry function of the present invention.

FIG. 13 shows an example of a real-time stock graph of the present invention.

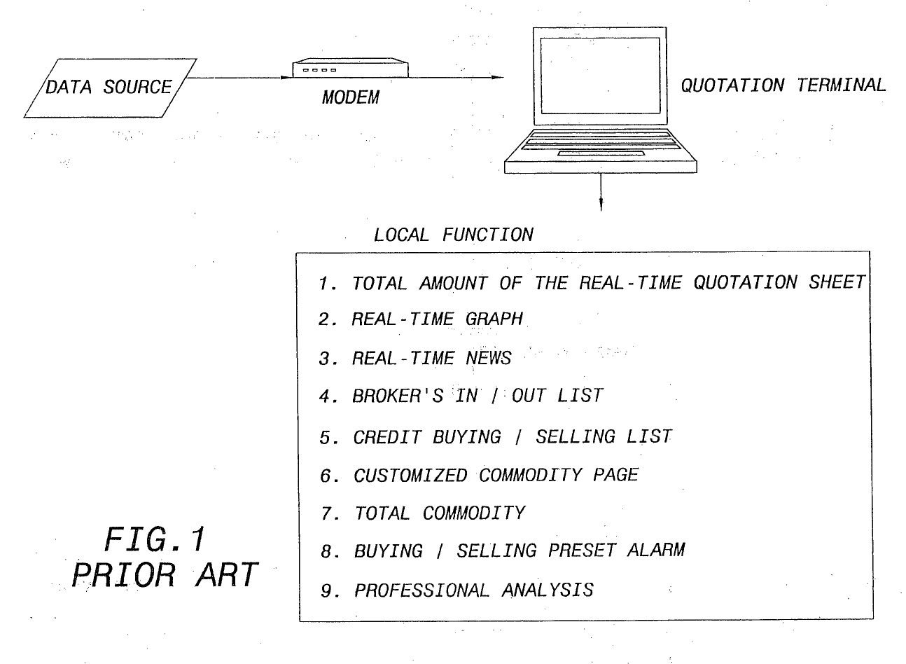

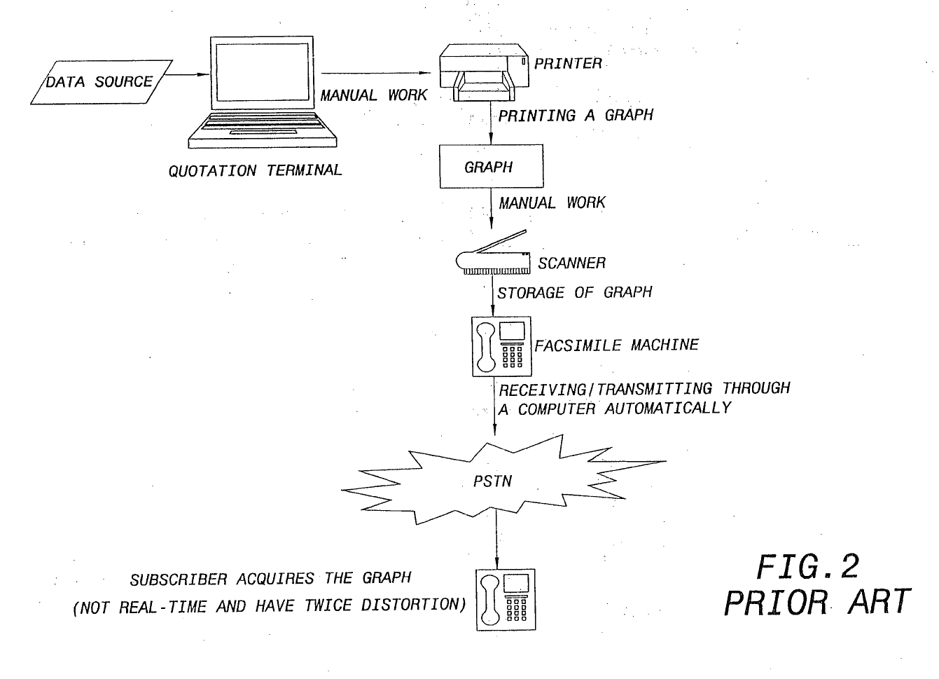

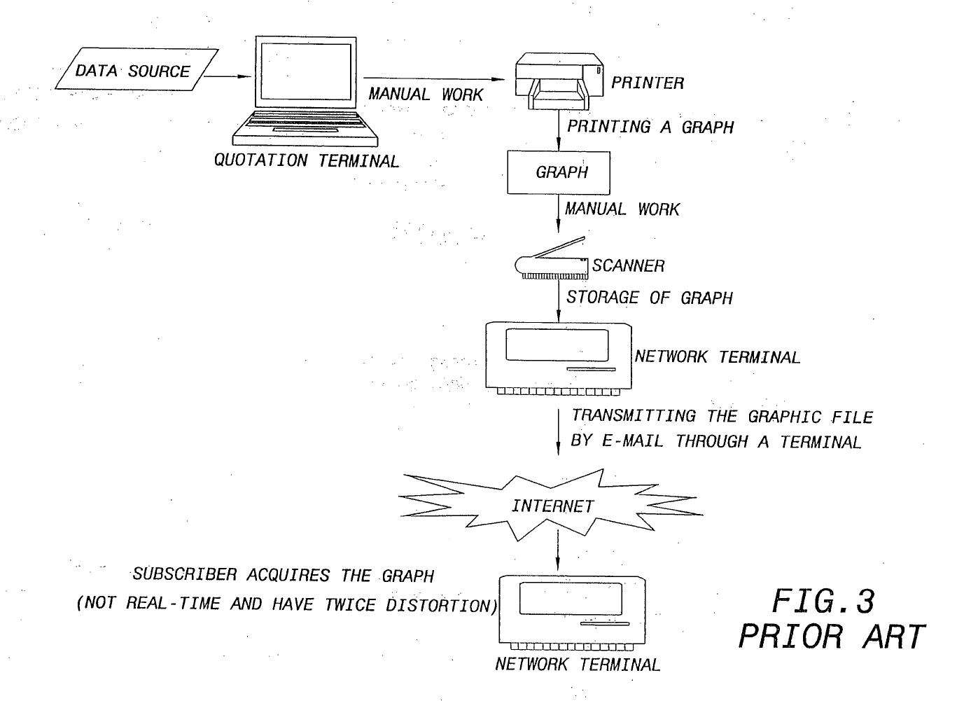

### DETAILED DESCRIPTION OF THE PREFERRED EMBODIMENTS

The object and construction of the present invention will be described in the following with the appended figures, thereby, those skilled in the art will fully understand the present invention.

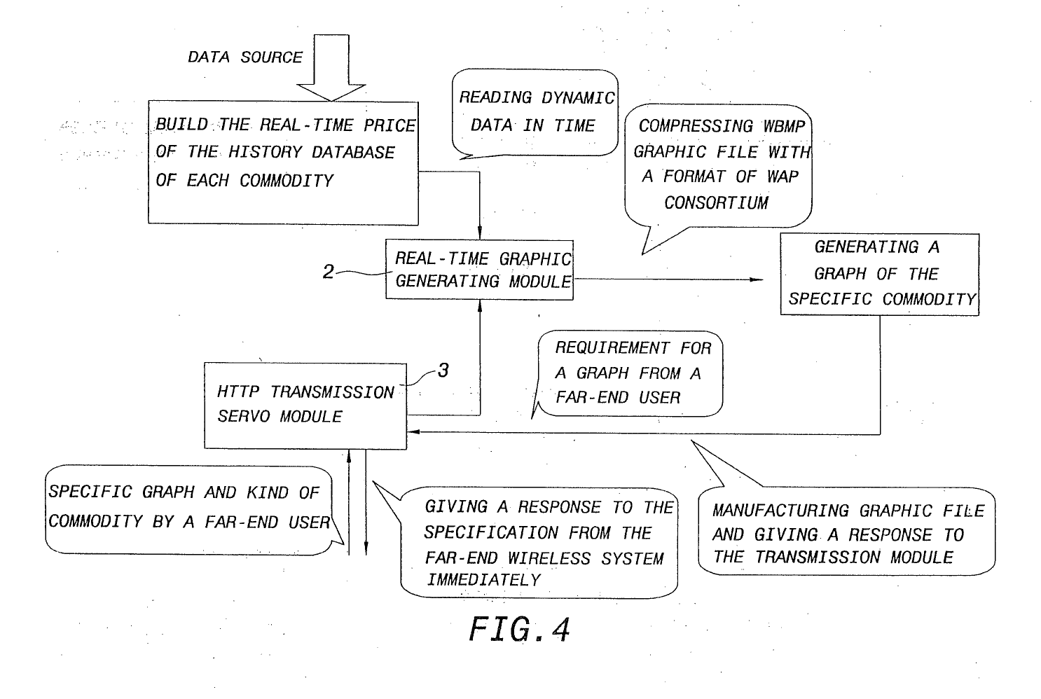

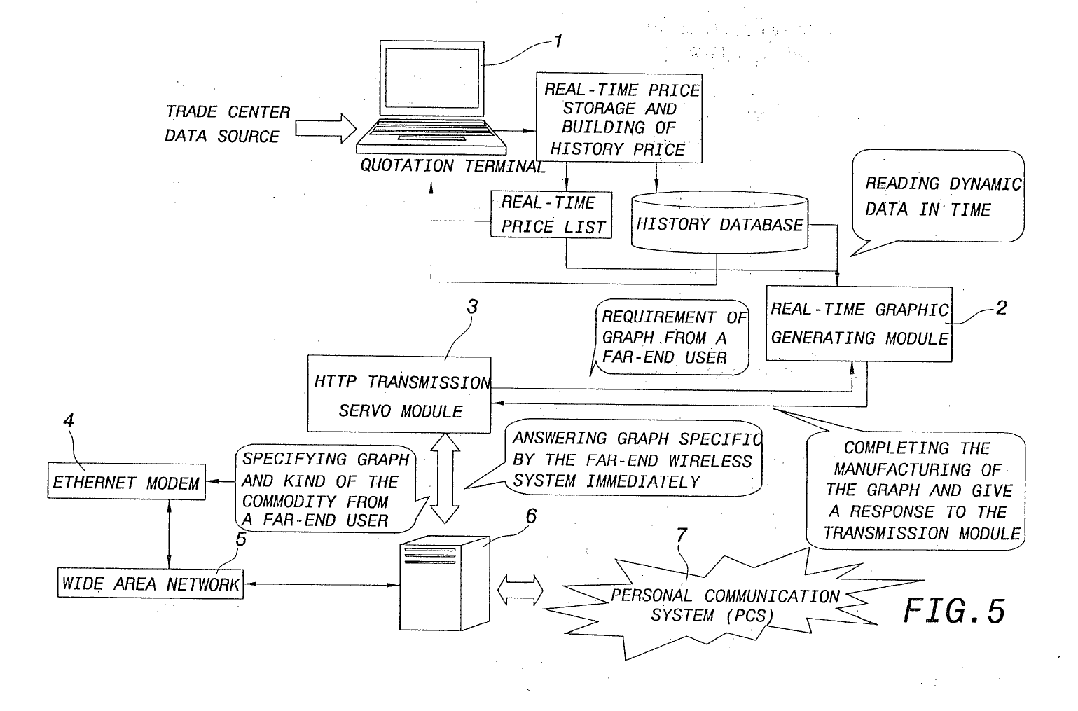

Referring to FIGS. 4, and 5, the method for wirelessly transmission of financial stock real-time graphs and the device of the same are illustrated herein. The device for wirelessly real-time transmission of financial stock graphs includes a finical quotation terminal 1, a hyper text transfer protocol transmission servo module (HTTP transmission servo module) 3 and other units.

The finical (for example, stocks, foreign exchanges, and futures) quotation terminal 1 quotes real-time prices and builds a history database according to the input data source and then the real-time prices and graphs are displayed through a displaying software.

The finical quotation terminal 1 is installed with an HTTP transmission servo module 3 conforming the hyper text transfer protocol (HTTP 1.0/1.1) standard. The HTTP transmission servo module 3 is connected to a wide area network (Wan) through an hardware interface, such as Ethernet, or serial communication interface (for example, RS232), or a modem 4, and therefore, the HTTP transmission servo module is further connected to a far-end wireless application protocol gateway (WAP gateway) 6 of a wireless digital system, such as GSM or CDMA. The WAP gateway 6 is a bridge between the HTTP transmission protocol and wireless application protocol and is responsible for the service of a real-time graphic information so as to be accessed by the customers of mobile phones or mobile personal assistant application.

A far-end user may enter into the HTTP transmission servo module of the present finical quotation terminal 1 through a mobile terminal supporting with the WAP protocol and control the module through instructions matching a wireless mark language (WML) format so as to selectively generate and transfer a finical graphic information.

The method and flow of the finical quotation terminal 1 may be classified as an explicit way and an implicit way. In the explicit processing, a local user operates the terminal according to a conventional way and then the graph is displayed on a screen through a screen display module. In the implicit way, a far-end user read the price data stored in a database of a specific commodity through a real-time graphic generating module 2 in time. Then, the data is converted into bitmap coordinates, then is stored in the register in a terminal operating system, and then is directly translated and compressed into a WBMP graphic file matching with the specification of wireless device, bitmap coordinate established by the Wireless Application Protocol Forum. The transmission to the far-end user is performed through the HTTP transmission servo module 3, Ethernet, serial communication interface and modem 4 in the present terminal.

Since the graphic file is not optically scanned after printed through a printer, it is not performed in-time and has a lower resolution. In fact, the graphic file is from a real-time market data and then is converted into a digital graphic file and it is directly transferred through a digital protocol, therefore, it is provided in time and has a high resolution.

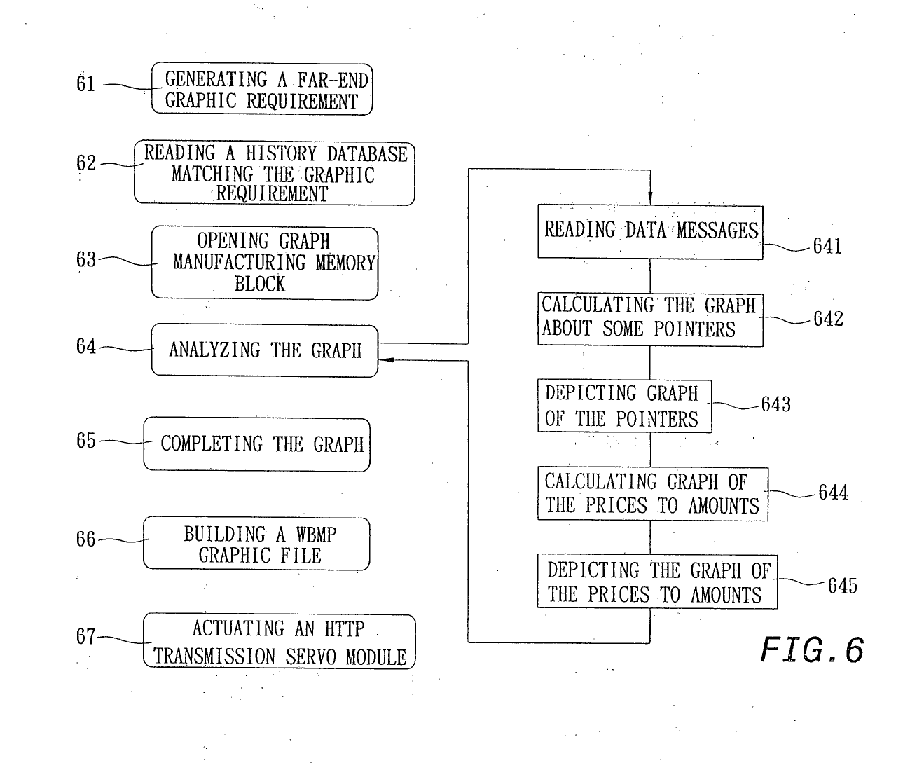

Referring to FIG. 6, the flow diagram of the real-time graphic generating module of the finical quotation terminal according to the present invention. The process comprises the steps of at first, generating a far-end graphic requirement (step 61); then reading a history database matching the graphic requirement (step 62); opening graph manufacturing memory block (step 63); analyzing the graph (step 64) (including the sub-steps of reading data messages (step 641), calculating the graph about some pointers (step 642), depicting graph of the pointers (step 643); calculating graph of the prices to amounts (step 644) and depicting the graph of the prices to amounts (step 645)). After the graph is complete (step 65), a WBMP graphic file 66 is built. Then a transmission servo module 67 is actuated for transferring the graphic file.

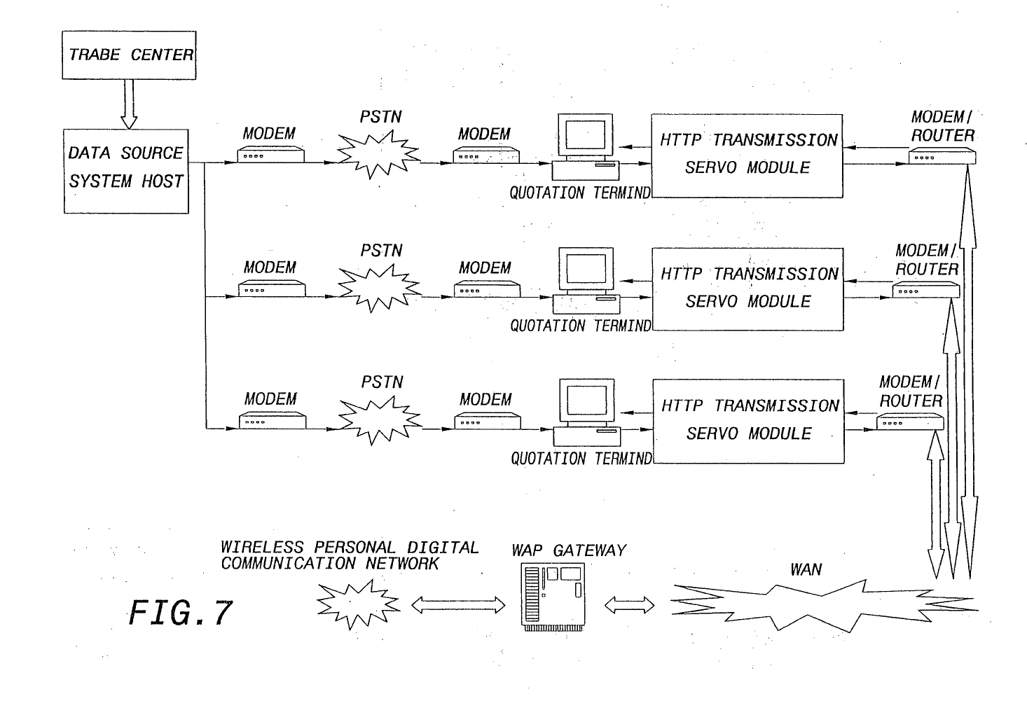

FIG. 7 shows the connection of the finical quotation terminal of the present invention with the host of data source system. A dial to a network is through a public service telephone network (PSTN) to accept the data broadcast of the system host of data source to all the finical quotation terminals. Each minutes, a time synchronous code is transferred so that each terminal has the following functions:
1. Timing of each terminal is calibrated so as to be synchronous to the system host.
2. Each terminal can feel that the data flow is interrupted since the interruption of timing code. For example, a far-end user in inquiring may be acknowledged from the message (such as the data is interrupted, and the current price is wrong) of a screen of a mobile device as the data flow is interrupted.
3. The finical quotation terminal of the present invention bidirectionally handshakes to the data source system host so that the connection is interruption, it can be connected again. The lost section of history data can be compensated automatically from the last time synchronous code).

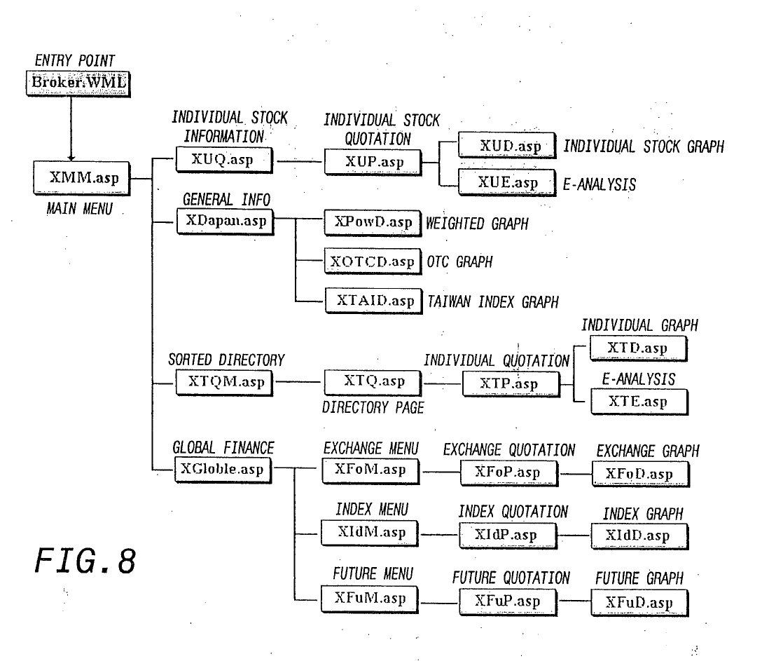

Referring to FIG. 8, the function construction of the finical quotation terminal according to the present invention is illustrated. As shown in the figures, the present invention is not only operated locally, but also the finical information can be controlled remotely.

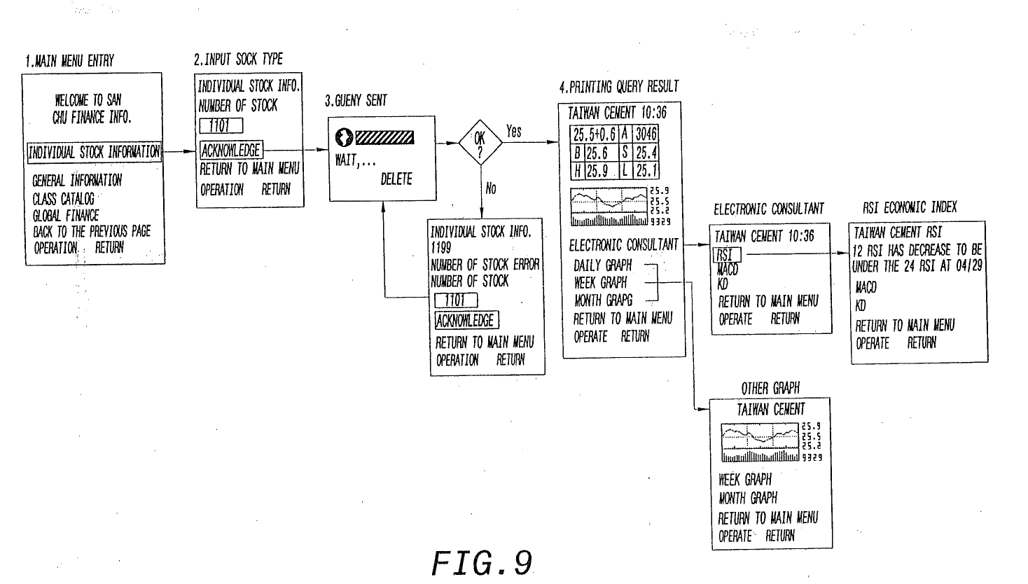

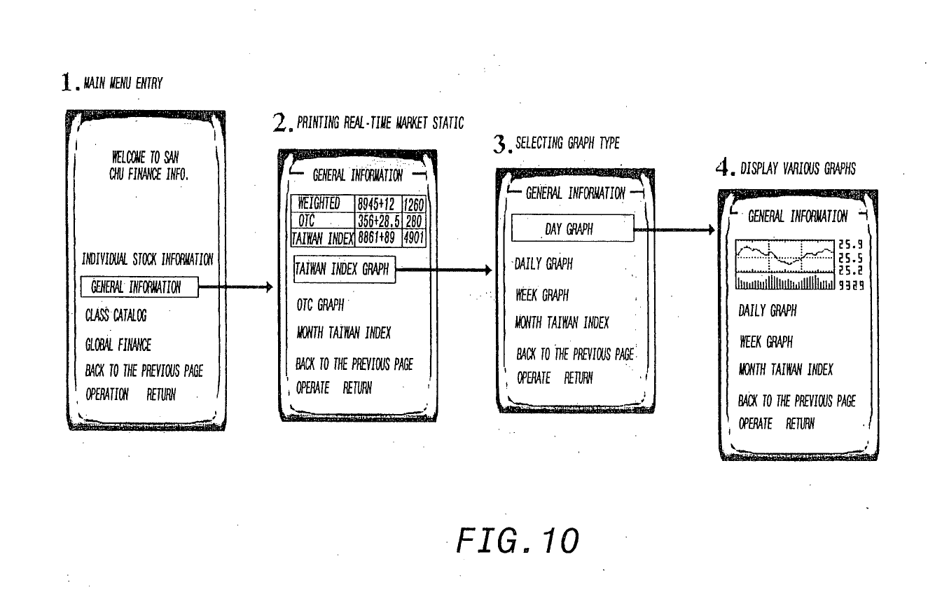

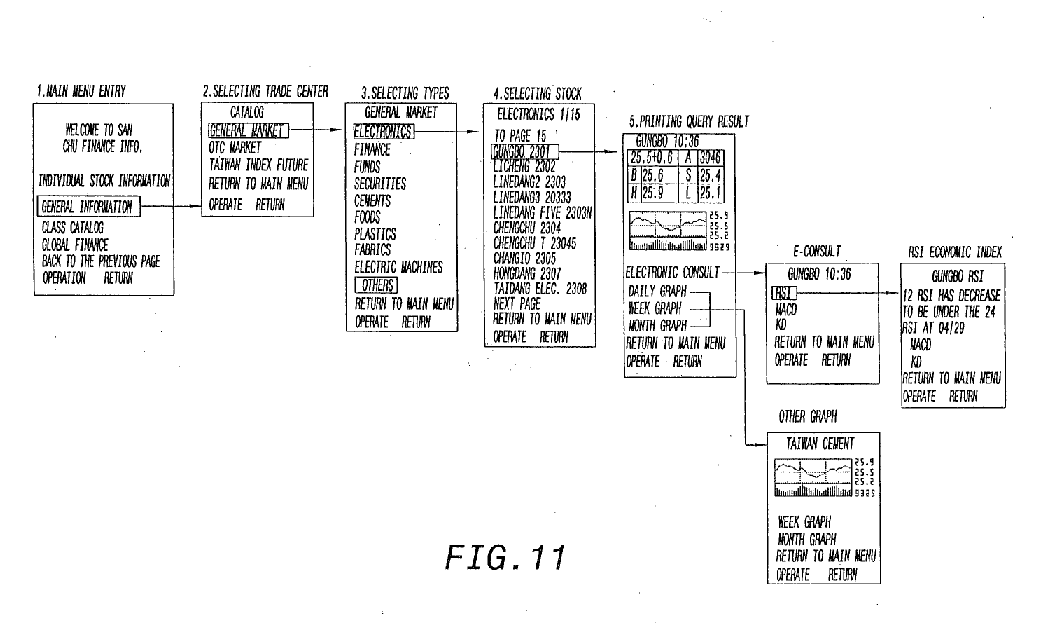

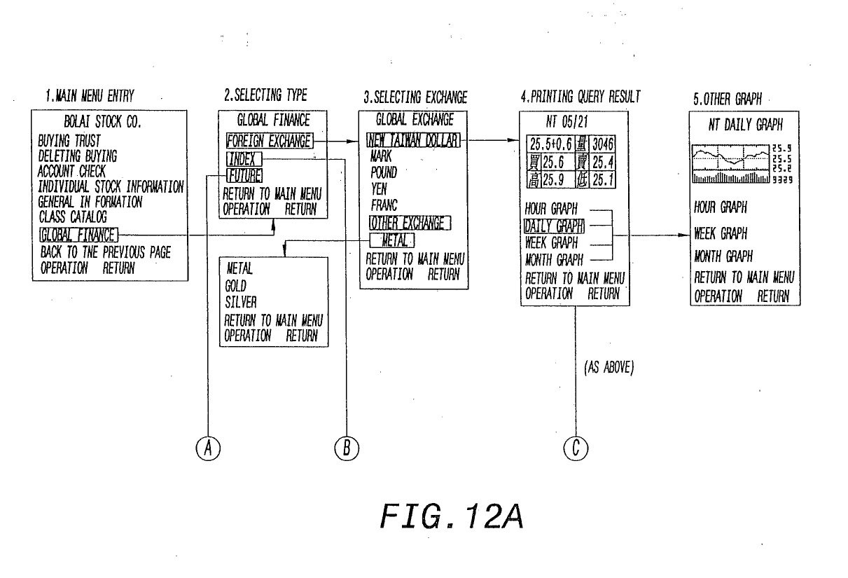

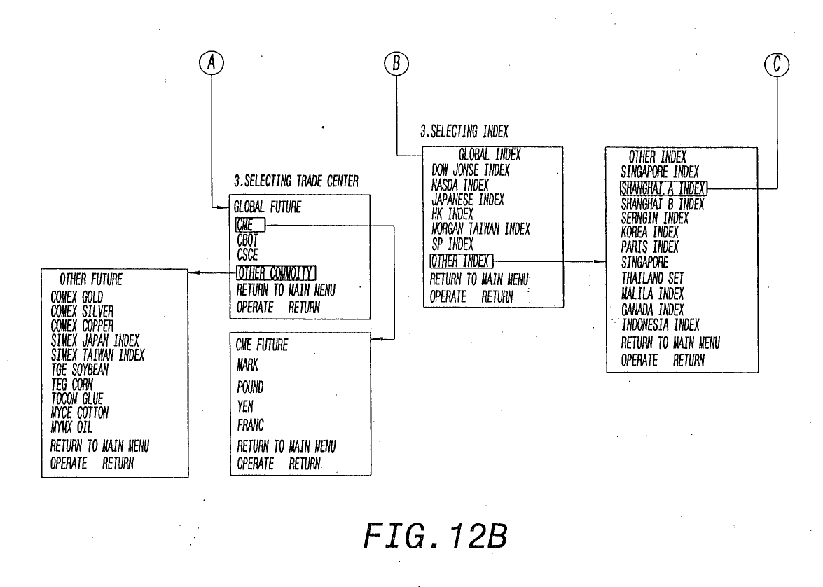

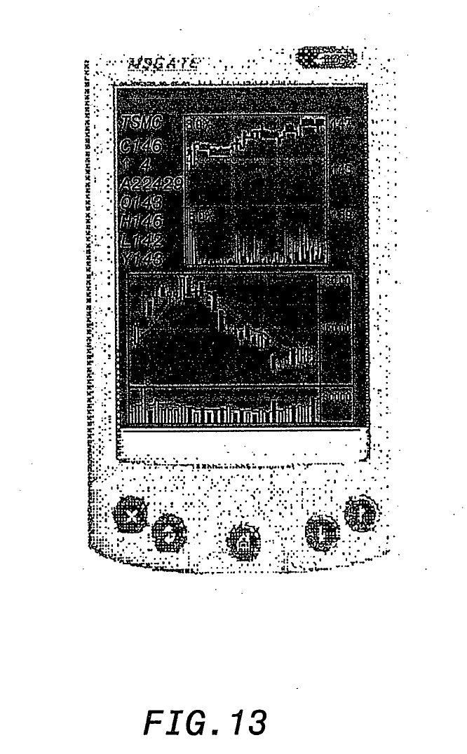

Referring to FIGS. 9 to 13, FIG. 9 is a description about the operation of the function of an individually stock; FIG. 10 is a description about the general stock market information; FIG. 11 is a description about the individual stock; FIGS. 12A and 12B are a description about the global information; and FIG. 13 is an example about the real-time graph of a stock of the present invention. It is appreciated that the present invention is different from the prior art finical speech quotation system, and has a great improvement from the conventional computer finical quotation terminal. It is not only controlled locally, but also is applicable remotely.

In summary, through the present invention, a mobile communication device (for example, a WAP mobile phone, or a personal digital assistant (PDA)) can acquire the real-time information and graph of a finical commodity, history prices, or news, and other information of a stock. The present invention is different from the conventional finical quotation terminal which is only controlled locally and can not be used remotely. Furthermore, the real-time information and high resolution the present invention is superior than the prior art in which information is scanned, and printed and then is faxed or mailed to the user. Moreover, for the prior art finical quotation fax system, the far-end user needs facsimile machine and is confined by the layout of a public service telephone network (PSTN) and thus, this prior art system is inconvenient. Alternatively, the HTTP transmission servo module of the present invention is constructed in wide area network with a frame of package switch instead of the prior art finical information fax system matching to a PSTN with a frame of circuit switch. Therefore, many users may connect to the system of the present invention at the same time and thus, the object of sharing information in common is achieved.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1-9. (canceled)

10. A method for wireless real-time transmission of financial stock graphs comprising the steps of:
sending a request for a graph of a specific financial commodity to a hyper text transfer protocol transmission servo module of a financial quotation terminal at a first location from a far-end user terminal at a second location, the far-end user terminal being supported by a wireless markup language (WML) and the request being sent through a communication network that includes a mobile network for communication with the far-end user terminal;
at the first location, reading data stored in a database through a real-time graphic generating module according to the specific financial commodity;
translating and compressing the read data into a graphic file at the first location with a wireless bitmap format established by the wireless application protocol consortium, said graphic file containing a graphical two-dimensional plot of said read data; and
transferring the graphic file to the far-end user terminal through the far-end user terminal through the hyper text transfer protocol transmission servo module and the communication network.

11. The method for wireless real-time transmission of financial stock graphs as claimed in claim 10, wherein the communication network over which the far-end user terminal communicates with the hyper text transfer protocol transmission servo module additionally includes a wide area network.

12. The method for wireless real-time transmission of financial stock graphs as claimed in claim 10, wherein the communication network over which the far-end user terminal communicates with the hyper text transfer protocol transmission servo module additionally includes an Ethernet link.

13. A device for wireless real-time transmission of financial stock graphs comprising:
a far end mobile user terminal supported by WAP protocol;
a financial quotation terminal;
a real-time graphic generating module connected to the financial quotation terminal, and
a hyper text transfer protocol transmission servo module (HTTP transmission servo module) connected to the real-time graphic generating module, and
a wireless application protocol gateway for communication with the far-end mobile user terminal through a mobile network or a mobile digital system,
wherein a far-end user of the far-end mobile user terminal communicates with the HTTP transmission servo module and controls the HTTP transmission servo module through instructions using a wireless markup language (WML) format so as to selectively generate and transfer a finical graphic information, said financial graphic information being presented to the far-end user in the form of a graphical two dimensional plot.

14. The device for wireless real-time transmission of financial stock graphs as claimed in claim 13, wherein the far-end mobile user terminal is a mobile phone.

15. The device for wireless real-time transmission of financial stock graphs as claimed in claim 13, wherein the far-end mobile terminal is a 20 personal digital assistant (PDA).

16. The device for wireless real-time transmission of financial stock graphs as claimed in claim 13, wherein the hyper text transfer protocol transmission servo module is connected to the wireless application protocol gateway through an Ethernet link, or a serial communication interface and a modem.

13. The device for wireless real-time transmission of financial stock graphs as claimed in claim 4, wherein the mobile network is a wide area network (WAN).

14. The device for wirelessly real-time transmission of financial stock graphs as claimed in claim 13, wherein the mobile network comprises the internet.
